(19) United States
(12) Patent Application Publication
(10) Pub. No.: US 2009/0053642 A1
(43) Pub. Date: Feb. 26, 2009

(54) TONER, METHOD OF FORMING IMAGES USING THE TONER AND IMAGE FORMING DEVICE USING THE TONER

(75) Inventors: Min-young Cheong, Seoul (KR); Kyung-yol Yon, Seongnam-si (KR); Jun-young Lee, Seoul (KR); Kyeong Pang, Suwon-si (KR); Su-bum Park, Daegu (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/180,735

(22) Filed: Jul. 28, 2008

(30) Foreign Application Priority Data
Aug. 21, 2007 (KR) 2007-83953

(51) Int. Cl. G03G 9/113; B05C 5/02; G03G 15/08

(52) U.S. Cl. 430/110.2; 118/46; 399/222

(57) ABSTRACT

A toner having a cohesion level of 50 or less when measured using an ASTM D 6393-99 includes a first agglomerated toner including latex particles for a core, a pigment and an inorganic salt, and latex particles for a shell layer coated on the first agglomerated toner, wherein the latex particles for the core and the latex particles for the shell layer are prepared by polymerizing a composition including an amphiphilic monomer having a hydrophilic group, a hydrophobic group and at least one reactive functional group, and a polymerizable monomer.

### CROSS-REFERENCE TO RELATED APPLICATIONS

This application claims priority from Korean Patent Application No.10-2007-0083953, filed on Aug. 21, 2007, in the Korean Intellectual Property Office, the disclosure of which is incorporated herein in its entirety by reference.

### BACKGROUND OF THE INVENTION

1. Field of the Invention

The present general inventive concept relates to a toner, a method of forming images using the toner and an image forming device using the toner, and more particularly, to a toner having improved fluidity, improved durability, and excellent charging stability, a method of forming images using the toner, and an image forming device using the toner.

2. Description of the Related Art

In electrophotographic processes or electrostatic recording processes, a developer used to shape an electrostatic image or an electrostatic latent image is classified into a two-component developer formed of toner and carrier particles and a one-component developer formed only of a toner. The one-component developer is classified into a magnetic one-component developer and a nonmagnetic one-component developer. Fluiding agents such as colloidal silica are often independently added to the nonmagnetic one-component developer in order to increase the fluidity of the toner. Typically, coloring particles obtained by dispersing a pigment such as carbon black, or other additives in a binding resin are used as the toner.

Toner can be prepared by pulverization or polymerization. In pulverization, the toner is obtained by melting and mixing synthetic resins with pigments and, if required, other additives, pulverizing the mixture, and sorting the particles until particles of a desired size are obtained. In polymerization, a polymerizable monomer composition is manufactured by uniformly dissolving or dispersing various additives such as a pigment, a polymerization initiator and, if required, a cross-linking agent and an antistatic agent in a polymerizable monomer. Then, the polymerizable monomer composition is dispersed in an aqueous dispersive medium which includes a dispersion stabilizer using an agitator in order to shape minute liquid droplet particles. Subsequently, the temperature of the mixture is increased and suspension polymerization is performed in order to obtain a polymerized toner having coloring polymer particles of a desired size.

In an image forming apparatus such as an electrophotographic apparatus or an electrostatic recording apparatus, an image is formed by exposing an image on a uniformly charged photoreceptor to form an electrostatic latent image, attaching a toner to the electrostatic latent image to form a toner image, transferring the toner image onto a transfer member such as transfer paper or the like, and then fixing the toner image on the transfer member by any of a variety of methods, including heating, pressurizing, solvent steaming and the like. In most fixing processes, the transfer medium with the toner image passes through fixing rollers and pressing rollers and the toner image is fused to the transfer medium by a heating and pressing process.

Images formed by an image forming apparatus such as an electrophotocopier should satisfy requirements such as high precision and accuracy. Conventionally, the toner used in an image forming apparatus is usually obtained using pulverization. In pulverization, color particles having sizes in a large range are formed. Therefore, in order to obtain satisfactory developing properties, there is a need to sort the coloring particles obtained through pulverization according to size to thereby reduce the particle size distribution. However, it is difficult to precisely control the particle size and the particle size distribution using a conventional mixing/pulverizing process in the manufacture of the toner which is suitable for an electrophotographic process or an electrostatic recording process. Also, when preparing a fine-particle toner, the toner preparation yield is adversely affected by the sorting process. In addition, there are limits to modification and/or adjustment of a toner design for obtaining desirable charging and fixing properties. Accordingly, since the size of particules of a polymerized toner are easy to control and which do not need to undergo a complex manufacturing process such as sorting, a polymerized toner has been highlighted recently.

When a toner is prepared through polymerization, a polymerized toner having a desired particle size and particle size distribution can be obtained without pulverizing or sorting. However, although such polymerization is used, a surfactant is required to disperse a pigment. However, the use of the surfactant requires a washing process, and therefore manufacturing costs associated therewith increases and an amount of wastewater generated thereby also increases.

For example, U.S. Pat. No. 6,258,911 invented by Michael, etc. discloses a bifunctional polymer having narrow polydispersity and a method of emulsification-aggregation polymerization for preparing a polymer having free radicals that are covalently-bonded at both ends of the polymer. In such an emulsification-aggregation polymerization, toner particles are prepared by separately preparing a wax dispersion and a pigment dispersion using an ionic surfactant (typically an anionic surfactant), dispersing the prepared polymer latex particles with the wax dispersion and the pigment dispersion using a surfactant, and then agglomerating the resultant dispersion. Alternatively, a polymer latex (or seed) is polymerized in a first operation, and the seed is polymerized with a wax-monomer emulsified dispersion using a seed-treated emulsion polymerization in a second operation, and then the toner particles are prepared by agglomerating the dispersed pigment using a surfactant. A method of preparing a toner using the conventional emulsification-aggregation is complicated and results in various problems due to residual surfactant, since the surfactant cannot be easily removed. Particularly, the conventional methods require additional operations such as a washing process and thus increase pollution to the environment and also increase manufacturing costs associated therewith.

In addition, when the surfactant such as an emulsifier or dispersant is removed, hydrophobicity of the toner is increased. Thus, as the particle size of the toner decreases, cohesion among the toner particles increase, thereby requiring a sorting process. Therefore, the yield of the toner may decrease and the costs for manufacturing the toner may increase.

### SUMMARY OF THE INVENTION

The present general inventive concept provides a toner having improved fluidity due to low cohesion among toner particles, improved durability by forming a shell layer on the toner, and excellent charging stability.

Additional aspects and/or utilities of the present general inventive concept will be set forth in part in the description which follows and, in part, will be obvious from the description, or may be learned by practice of the general inventive concept.

The present general inventive concept also provides a method of forming high-quality images which can be fixed at a low temperature using a toner having excellent properties such as fluidity, storability and durability.

The present general inventive concept also provides an image forming device which can form a high-quality image and can be fixed at a low temperature using a toner having excellent properties such as fluidity, storability and durability.

The foregoing and/or other aspects and utilities of the present general inventive concept may be achieved by providing a toner having a cohesion level of 50 or less when measured using an ASTM D 6393-99 includes a first agglomerated toner including latex particles for a core, a pigment and an inorganic salt and latex particles for a shell layer coated on the first agglomerated toner, wherein the latex particles for the core and the latex particles for the shell layer are prepared by polymerizing a composition including an amphiphilic monomer having a hydrophilic group, a hydrophobic group and at least one reactive functional group, and a polymerizable monomer.

A weight average molecular weight of the amphiphilic monomer may range from about 100 to about 100,000.

The amphiphilic monomer may be selected from the group consisting of polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxy polyester acrylate, fatty acid modified epoxy acrylate, and polyester methacrylate.

The composition may include about 0.5 to about 10 parts by weight of the amphiphilic monomer based on 100 parts by weight of the polymerizable monomer.

The polymerizable monomer may be at least one monomer selected from the group consisting of styrene-based monomers; acrylic acid, methacrylic acid; derivatives of (metha)acrylates; ethylenically unsaturated monoolefins; halogenized vinyls; vinyl esters; vinyl ethers; vinyl ketones; and nitrogen-containing vinyl compounds.

The composition may further include at least one selected from the group consisting of a wax, an initiator, a chain transfer agent, a charge control agent and a releasing agent.

The wax may be selected from the group consisting of polyethylene-based wax, polypropylene-based wax, silicon wax, paraffin-based wax, ester-based was, carbauna wax and metallocene wax.

The initiator may be selected from the group consisting of persulfate salts, azo compounds, and peroxides.

The chain transfer agent may be selected from the group consisting of sulfur containing compounds, phosphorous acid compounds, hypophosphorous acid compounds, and alcohols.

The release agent may be selected from the group consisting of low molecular weight polyolefins, low molecular weight polyethylene, paraffin wax, and multi-functional ester compounds.

The charge control agent may be selected from the group consisting of a salicylic acid compound containing metals such as zinc and aluminum, boron complexes of bis diphenyl glycolic acid, and silicate.

The pigment may be selected from the group consisting of yellow, magenta, cyan and black pigments.

The inorganic salt may be at least one selected from the group consisting of NaCl, MgCl₂ .8 H₂0, [Al₂(OH)ₙCl₆₋ₙ]ₘ where 1≦n≦5 and 1≦m≦10 and Al₂(SO₄)₃.18H₂O.

A volume average diameter of particles of the toner may be in the range of about 5 μm to about 10 μm.

The foregoing and/or other aspects and utilities of the present general inventive concept may be achieved by providing a method of forming images using a toner the toner having a cohesion level of 50 or less when measured using an ASTM D 6393-99 includes a first agglomerated toner including latex particles for a core, a pigment and an inorganic salt, and latex particles for a shell layer coated on the first agglomerated toner, wherein the latex particles for the core and the latex particles for the shell layer are prepared by polymerizing a composition including an amphiphilic monomer having a hydrophilic group, a hydrophobic group and at least one reactive functional group, and a polymerizable monomer, the method includes attaching the toner to a surface of a photoreceptor on which an electrostatic latent image is formed to form a visualized image and transferring the visualized image to a transfer medium.

The foregoing and/or other aspects and utilities of the present general inventive concept may be achieved by providing an image forming apparatus which includes an organic photoreceptor, an image forming unit that forms an electrostatic latent image on a surface of the organic photoreceptor, a unit for receiving a toner, the toner having a cohesion level of 50 or less when measured using an ASTM D 6393-99, the toner includes a first agglomerated toner including latex particles for a core, a pigment and an inorganic salt, and latex particles for a shell layer coated on the first agglomerated toner, wherein the latex particles for the core and the latex particles for the shell layer are prepared by polymerizing a composition including an amphiphilic monomer having a hydrophilic group, a hydrophobic group and at least one reactive functional group, and a polymerizable monomer, a toner supplying unit that supplies the toner onto the surface of the organic photoreceptor in order to form a toner image by developing the electrostatic latent image, and a toner transferring unit that transfers the toner image to a transfer medium from the surface of the organic photoreceptor.

A weight average molecular weight of the amphiphilic monomer may range from about 100 to about 100,000.

The amphiphilic monomer may be selected from the group consisting of polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxy polyester acrylate, fatty acid modified epoxy acrylate, and polyester methacrylate.

The composition may include about 0.5 to about 10 parts by weight of the amphiphilic monomer based on 100 parts by weight of the polymerizable monomer.

The polymerizable monomer may be at least one monomer selected from the group consisting of styrene-based monomers; acrylic acid, methacrylic acid; derivatives of (metha)acrylates; ethylenically unsaturated monoolefins; halogenized vinyls; vinyl esters; vinyl ethers; vinyl ketones; and nitrogen-containing vinyl compounds.

The composition may further include at least one selected from the group consisting of wax, an initiator, a chain transfer agent, a charge control agent and a releasing agent.

The wax may be selected from the group consisting of polyethylene-based wax, polypropylene-based wax, silicon wax, paraffin-based wax, ester-based was, carbauna wax and metallocene wax.

The initiator may be selected from the group consisting of persulfate salts, azo compounds, and peroxides.

The chain transfer agent may be selected from the group consisting of sulfur containing compounds, phosphorous acid compounds, hypophosphorous acid compounds, and alcohols.

The release agent may be selected from the group consisting of low molecular weight polyolefins, low molecular weight polyethylene, paraffin wax, and multi-functional ester compounds.

The charge control agent may be selected from the group consisting of a salicylic acid compound containing metals such as zinc and aluminum, boron complexes of bis diphenyl glycolic acid, and silicate.

According to the present general inventive concept, a toner for a high-quality and a high-speed printer can be provided since the fluidity of the toner can be improved due to low cohesion among toner particles created by decreasing hydrophobicity of the surface of the toner using an amphiphilic monomer on the surface of the toner instead of a surfactant, and thus a washing process can be improved and yields of the toner can be increased, durability of the toner can be improved by forming a shell layer on the surface of the toner, and charging stability can also be increased.

### BRIEF DESCRIPTION OF THE DRAWINGS

The above and/or other features and utilities of the present general inventive concept will become more apparent by describing in detail exemplary embodiments thereof with reference to the attached drawings in which:

FIG. 1 illustrates an image forming apparatus employing a toner prepared according to an exemplary embodiment of the present general inventive concept;

FIG. 2 illustrates a scanning electron microscope (SEM) image of the toner prepared according to Example 1;

FIG. 3 illustrates a SEM image of toner prepared according to Example 2;

FIG. 4 illustrates a SEM image of toner prepared according to Example 3;

FIG. 5 illustrates a SEM image of toner prepared according to Example 4;

FIG. 6 illustrates a SEM image of toner prepared according to Example 5;

FIG. 7 illustrates a SEM image of toner prepared according to Example 6; and

FIG. 8 illustrates a SEM image of toner prepared according to Comparative Example 1.

### DETAILED DESCRIPTION OF THE PREFERRED EMBODIMENTS

Hereinafter, the present general inventive concept will now be described more fully with reference to the accompanying drawings, in which exemplary embodiments of the invention are illustrated.

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

The present general inventive concept can provide a toner having improved fluidity due to low cohesion by decreasing hydrophobicity of a surface of the toner by using an amphiphilic monomer on the surface of the toner. In addition, the present general inventive concept can also provide a toner for a high-quality and a high-speed printer with improved durability and excellent charging stability by including a shell layer on the toner. In addition, an amount of wastewater can be minimized by decreasing the amount of a surfactant used when the toner is prepared using an amphiphilic monomer instead of the surfactant.

The present general inventive concept provides a toner having a cohesion level 50 or less when measured using an ASTM D 6393-99 which includes a first agglomerated toner including latex particles for a core, a pigment and an inorganic salt, and latex particles for a shell layer coated on the first agglomerated toner, wherein the latex particles for the core and the latex particles for the shell layer are prepared by polymerizing a composition which includes an amphiphilic monomer having a hydrophilic group, a hydrophobic group and at least one reactive functional group, and a polymerizable monomer.

In an exemplary embodiment, the amphiphilic monomer used herein is an amphiphilic material including both a hydrophilic group and a hydrophobic group in a polymer or oligomer form having at least one reactive functional group at its ends. However, the present general inventive concept is not limited thereto.

The hydrophilic group of the amphiphilic monomer which is chemically combined with the surface of the toner particles improves long term stability of the toner particles by steric stabilization, and the size of the latex particles can be adjusted according to an amount or molecular weight of the added amphiphilic monomer. In exemplary embodiments, the hydrophobic group of the amphiphilic monomer which is on the surface of the toner particles can facilitate an emulsion polymerization reaction. In an exemplary embodiment, the amphiphilic monomer may form a copolymer with the polymerizable monomer contained within the toner composition by grafting, branching, cross-linking, or the like. However, the present general inventive concept is not limited thereto.

In an exemplary embodiment, a weight average molecular weight of the amphiphilic monomer may be in the range of about 100 to about 100,000, and more specifically, in a range of about 1,000 to about 10,000. When the weight average molecular weight of the amphiphilic monomer is less than 100, physical properties of the toner are not improved or the toner cannot function as a stabilizer efficiently. On the other hand, when the weight average molecular weight of the amphiphilic monomer is greater than 100,000, the reaction conversion rate may be lowered.

In exemplary embodiments, the amphiphilic monomer may be a material selected from a group consisting of polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxy polyester acrylate, fatty acid modified epoxy acrylate and polyester methacrylate. However, the present general inventive concept is not limited thereto.

In an exemplary embodiment, the amphiphilic monomer may function as a comonomer and as a stabilizer. Initial reaction of radicals and monomers creates oligomer radicals and portrays an in-situ stabilization effect. An initiator dissolved by heat creates radicals and reacts with a monomer in an aqueous solution to form an oligomer radical, and the hydrophobicity of the solution increases. Such hydrophobicity of oligomer radicals facilitates diffusion into micelle and facilitates reaction with polymerizable monomers, and together with this, a copolymerization reaction with amphiphilic monomers can be processed.

In an exemplary embodiment, copolymerization may easily occur in the vicinity of the surface of the toner particles due to the hydrophilicity of the amphiphilic monomer. The hydrophilic portions of the amphiphilic monomer located on the surface of the toner particles increase stability of the toner particles by steric stabilization, and the size of the toner particles may be adjusted according to the amount or molecular weight of the amphiphilic monomers. In addition, functional groups reacting on the surface of the toner particles can improve the frictional electrical properties of the toner. However, the present general inventive concept is not limited thereto.

In an exemplary embodiment, the polymerizable monomer may be at least one monomer selected from a group consisting of styrene-based monomers, acrylic acid, methacrylic acid, derivatives of (metha)acrylates, ethylenically unsaturated monoolefins, halogenized vinyls, vinyl esters, vinyl ethers, vinyl ketones, and nitrogen-containing vinyl compounds. However, the present general inventive concept is not limited thereto.

In exemplary embodiments, the polymerizable monomer may be at least one monomer selected from a group consisting of styrene-based monomers such as styrene, vinyl toluene and α-methyl styrene; acrylic acid or methacrylic acid; derivatives of (metha)acrylates such as methyl acrylate, ethyl acrylate, propyl acrylate, butyl acrylate, 2-ethylhexyl acrylate, dimethylamino ethyl acrylate, methyl methacrylate, ethyl methacrylate, propyl methacrylate, butyl methacrylate, 2-ethylhexyl methacrylate, dimethylaminoethyl methacrylate, acrylonitrile, methacrylonitrile, acrylamide and metacryl amide; ethylenically unsaturated monoolefins such as ethylene, propylene and butylenes; halogenized vinyls such as vinyl chloride, vinylidene chloride and vinyl fluoride; vinyl esters such as vinyl acetate and vinyl propionate; vinyl ethers such as vinyl methyl ether and vinyl ethyl ether; vinyl ketones such as vinyl methyl ketone and methyl isoprophenyl ketone; and nitrogen-containing vinyl compounds such as 2-vinylpyridine, 4-vinylpyridine and N-vinyl pyrrolidone. However, the present general inventive concept is not limited thereto.

As described above, the latex particles for a core and the latex particles for a shell layer are prepared by polymerizing a composition including an amphiphilic monomer having a hydrophilic group, a hydrophobic group and at least one reactive functional group, and at least one polymerizable monomer.

In an exemplary embodiment, the composition may include about 0.5 to about 10 parts by weight, and more specifically about 1.0 to about 3.0 parts by weight, of the amphiphilic monomer based on 100 parts by weight of the polymerizable monomer. However, the present general inventive concept is not limited thereto.

When an amount of the amphiphilic monomer is less than 0.5 parts by weight, dispersion stability of the toner particles may be decreased and a yield of the toner may be decreased. On the other hand, when the amount of the amphiphilic monomer is greater than 10 parts by weight, charge properties of the toner may deteriorate in a highly humid environment due to a large amount of the amphiphilic monomer on the surface of the toner or fluidity of the toner may be decreased since the glass transition temperature of the toner is relatively low.

In exemplary embodiments, the composition for the preparation of the latex particles for a core and the latex particles for a shell layer may further include at least one material selected from a group consisting of a wax, an initiator, a chain transfer agent, a charge control agent and a releasing agent. However, the present general inventive concept is not limited thereto.

Exemplary embodiments of the wax include polyethylene-based wax, polypropylene-based wax, silicon wax, paraffin-based wax, ester-based was, carbauna wax and metallocene wax. However, the present general inventive concept is not limited thereto. In an exemplary embodiment, the melting point of the wax may be in the range of about 50 to about 1 50° C. In exemplary embodiments, wax constituents are physically attached to the toner particles, but are not covalently bonded with toner particles. Thus, a toner which is fixed at a low fixing temperature on a final image receptor and portrays excellent final image durability and resistance to abrasion can be provided thereby. However, the present general inventive concept is not limited thereto. That is, the wax constituents may be bonded with the toner particles.

Exemplary embodiments of the initiator for radical polymerization may include persulfate salts such as potassium persulfate and ammonium persulfate; azo compounds such as 4,4-azobis(4-cyano valeric acid), dimethyl-2,2′-azobis(2-methyl propionate), 2,2-azobis(2-amidinopropane)dihydrochloride, 2,2-azobis-2-methyl-N-1, 1-bis(hydroxymethyl)-2-hydroxyethylpropioamide, 2,2′-azobis(2,4-dimethyl valeronitrile), 2,2′-azobis isobutyronitrile and 1,1′-azobis(1-cyclohexanecarbonitrile); and peroxides such as methyl ethyl peroxide, di-t-butylperoxide, acetyl peroxide, dicumyl peroxide, lauroyl peroxide, benzoyl peroxide, t-butylperoxy-2-ethyl hexanoate, di-isopropyl peroxydicarbonate and di-t-butylperoxy isophthalate. However, the present general inventive concept is not limited thereto. In addition, in an exemplary embodiment, an oxidization-reduction initiator in which the polymerization initiator and a reduction agent are combined may be used.

In exemplary embodiments, radicals may be created by the initiator, and the radicals may react with the polymerizable monomer. The radicals may form a copolymer by reacting with the polymerizable monomer and reactive functional groups of the amphiphilic monomer.

A chain transfer agent is a material which converts a type of chain carrier in a chain reaction. A new chain has much less activity than that of a previous chain. In exemplary embodiments, the polymerization degree of the monomer may be reduced and new chains may be initiated by using the chain transfer agent. In addition, a molecular weight distribution may be adjusted using the chain transfer agent. However, the present general inventive concept is not limited thereto. That is, various other materials and/or techniques may be used to adjust the molecular weight of the toner.

Exemplary embodiments of the chain transfer agent include sulfur containing compounds such as dodecanthiol, thioglycolic acid, thioacetic acid and mercaptoethanol; phosphorous acid compounds such as phosphorous acid and sodium phosphite; hypophosphorous acid compounds such as hypophosporous acid and sodium hypophosphite; and alcohols such as methyl alcohol, ethyl alcohol, isopropyl alcohol and n-butyl alcohol. However, the present general inventive concept is not limited thereto.

In exemplary embodiments, the release agent may be used to protect a photoreceptor and prevent deterioration from developing, thereby obtaining a high quality image. In an exemplary embodiment, a release agent may be a high purity solid fatty acid ester material. Exemplary embodiments of the release agent include low molecular weight polyolefins such as low molecular weight polyethylene, low molecular weight polypropylene and low molecular weight polybutylene; paraffin wax; and multi-functional ester compounds. The release agent used in the current exemplary embodiment of the present general inventive concept may be a multifunctional ester compound composed of an alcohol having three functional groups or more and carboxylic acid. However, the present general inventive concept is not limited thereto.

In exemplary embodiments, the alcohol having three functional groups or more may be aliphatic alcohols such as glycerin, pentaerythritol and pentaglycerol; alicyclic alcohols such as chloroglycitol, quersitol and inositol; aromatic alcohols such as tris(hydroxymethyl) benzene; and sugar-alcohols such as D-erythrose, L-arabinose, D-mannose, D-galactose, D-fructose, L-lamunose, sucrose, maltose and lactose. However, the present general inventive concept is not limited thereto.

In exemplary embodiments, the carboxylic acid may be aliphatic carboxylic acids such as acetic acid, butyric acid, caproic acid, enantate, caprylic acid, pelargonic acid, capric acid, undecanoic acid, lauric acid, myristic acid, stearic acid, magaric acid, arachidic acid, cerotic acid, sorbic acid, linoleic acid, linolenic acid, behenic acid and tetrolic acid; alicyclic carboxylic acids such as cyclohexanecarboxylic acid, hexahydroisophthalic acid, hexahydroterephthalic acid and 3,4,5,6-tetrahydrophthalic acid; or aromatic carboxylic acids such as benzoic acid, cumic acid, phthalic acid, isophthalic acid, terephthalic acid, trimethic acid, trimellitic acid and hemimellitic acid. However, the present general inventive concept is not limited thereto.

In exemplary embodiments, the charge control agent may be selected from a group consisting of a salicylic acid compound containing metals such as zinc and aluminum, boron complexes of bis diphenyl glycolic acid and silicate. In an exemplary embodiment, dialkyl salicylic acid zinc, boro bis (1,1-diphenyl-1-oxo-acetyl potassium salt), or the like can be used. However, the present general inventive concept is not limited thereto.

In exemplary embodiments, a medium used herein may be an aqueous solution, an organic solvent, or a mixture thereof.

In exemplary embodiments, the toner may include a pigment and carbon black or an aniline black may be used as the pigment for a black toner. A nonmagnetic toner according to the present general inventive concept is efficient for preparing color toner. For color toner, carbon black or aniline black is used as a black colorant, and at least one of yellow, magenta and cyan pigments are further included for colored colorants.

In exemplary embodiments, a condensation nitrogen compound, an isoindolinone compound, an anthraquine compound, an azo metal complex or an allyl imide compound may be used for the yellow pigment. Particularly, C.I. pigment yellow 12, 13,14, 17, 62, 74, 83, 93, 94, 95, 109, 110, 111, 128, 129, 147, 168, 180, or the like can be used. However, the present general inventive concept is not limited thereto.

In exemplary embodiments, a condensation nitrogen compound, an anthraquine compound, a quinacridone compound, a base dye lake compound, a naphthol compound, a benzo imidazole compound, a thioindigo compound or a perylene compound may be used for the magenta pigment. Particularly, C.I. pigment red 2, 3, 5, 6, 7, 23, 48:2, 48:3, 48:4, 57:1, 81:1, 122, 144, 146, 166, 169, 177, 184, 185, 202, 206, 220, 221, 254, or the like can be used. However, the present general inventive concept is not limited thereto.

In exemplary embodiments, a copper phthalocyanine compound and derivatives thereof, an anthraquine compound, or a base dye lake compound may be used for the cyan pigment. Particularly, C.I. pigment blue 1, 7, 15, 15:1, 15:2, 15:3, 15:4, 60, 62, 66, or the like can be used. However, the present general inventive concept is not limited thereto.

Such pigments may be used alone or in a combination of at least two pigments, and are selected in consideration of color, chromacity, luminance, resistance to weather, dispersion property in toner, etc.

In exemplary embodiments, an amount of the pigment as described above may range from between about 0.1 to about 20 parts by weight based on 100 parts by weight of the polymerizable monomer. However, although the amount of the pigment should be sufficient to color the toner, when the amount of the pigment is less than 0.1 parts by weight based on 100 parts by weight of the polymerizable monomer, the coloring effect is not sufficient. On the other hand, when the amount of the pigment is greater than 20 parts by weight, the manufacture costs of the toner increase, and thus a sufficient frictional charge amount cannot be obtained.

In addition, the first agglomerated toner is prepared by adding an inorganic salt to a mixed solution of the latex particles for a core and the pigment dispersion and agglomerating the mixture. That is, the size of the first agglomerated toner is increased by increased ionic strength by the addition of the inorganic salt and collisions between the particles.

Particularly, when a concentration of the inorganic salt is heavier than a critical coagulation concentration (CCC), an electrostatic repulsive force between latex particles is offset, and thus agglomeration rapidly occurs due to Brownian motion of the polymer latex particles. When a concentration of the inorganic salt is lower than the CCC, agglomeration speed becomes slow, and thus agglomeration of particles may be controlled. In exemplary embodiments, the inorganic salt may be at least one selected from a group consisting of NaCl, MgCl₂.8H₂0, [Al₂(OH)ₙCl₆₋ₙ]ₘ where 1≦n≦5 and 1≦m≦10 and Al₂(SO₄)₃.18H₂O. However, the present general inventive concept is not limited thereto.

Toner according to the present general inventive concept may be prepared using a method which includes preparing latex particles for a core by polymerizing a composition containing an amphiphilic monomer having a hydrophilic group, a hydrophobic group and at least one reactive functional group, and at least one polymerizable monomer, preparing a first agglomerated toner by mixing the latex particles for a core with a pigment dispersion dispersed by the amphiphilic monomer and adding an inorganic salt, and coating latex particles for a shell layer on the first agglomerated toner.

An exemplary embodiment of a process of preparing the latex particles for a core and the first agglomerated toner and coating the first agglomerated toner with latex particles for a shell layer according to the present general inventive concept will be described in detail.

First, latex particles for a core are prepared by polymerizing a composition including the amphiphilic monomer and at least one polymerizable monomer. More particularly, while the inside of a reactor is purged with nitrogen gas or the like, a mixture solution of a medium such as a distilled deionized water (or a mixture of water and an organic solvent) and the amphiphilic monomer is added to the reactor and heated while stirring. An electrolyte or an inorganic salt such as NaOH or NaCl may be added thereto in order to adjust an ionic strength of the reaction medium. When the temperature inside the reactor reaches a predetermined level, an initiator, such as a water-soluble free radical initiator, may be introduced. Then, at least one polymerizable monomer may be added to the reactor using a semi-continuous method with a chain transfer agent. In the current exemplary embodiment, a polymerizable monomer may be slowly provided using a starved feed process in order to adjust a reaction speed and dispersibility of the solution. In exemplary embodiments, wax may further be added thereto in addition to the polymerizable monomer and the chain transfer agent.

In exemplary embodiments, the polymerization may be performed in the range of about 2 to about 12 hours and the polymerization time may be dependent on the reaction temperature and experimental conditions and determined by measuring a reaction speed and a conversion rate. In an exemplary embodiment, the latex particles for a core may be prepared by adding additional monomers in order to adjust durability or other properties of the toner.

In an exemplary embodiment, the latex particles for a core may be formed in a single layer as described above or may include a wax layer formed using a dispersion process in which at least one polymerizable monomer is dispersed in the wax. That is, the wax layer is formed by adding a dispersion prepared by adding a dispersion prepared by dispersing wax in a mixture of at least one polymerizable monomer with a solvent in a reactor containing latex particles for a core and further adding an initiator, or the like. In this case, the wax may not be added in a primarily prepared composition.

In an exemplary embodiment, when the wax layer is formed, a shell layer may further be formed by adding at least one polymerizable monomer to the reactor. In the current exemplary embodiment, an inhibitor may further be added thereto in order to prevent formation of new latex particles. In addition, the reaction may be performed using starved-feed processes in order to facilitate a coating of the polymerizable monomer mixture on the core particles.

In exemplary embodiments, when the latex particles for a core are prepared, a pigment may be dispersed using the amphiphilic monomer since the amphiphilic monomer can maintain dispersibility with both the hydrophilic group and the hydrophobic group. In an exemplary embodiment, a milling or a homogenizer may be used without limitation as a dispersing means and the first agglomerated toner is prepared by adding an inorganic salt to the prepared pigment dispersion and agglomerating the mixture.

In the current exemplary embodiment, the latex particles for a shell layer are prepared in a similar manner to the preparation of the latex particles for a core using a composition including at least one polymerizable monomer and the amphiphilic monomer. That is, while the inside of a reactor is purged with nitrogen gas or the like, a mixture solution of a medium such as distilled deionized water (or a mixture of water and an organic solvent) and the amphiphilic monomer is added to the reactor and heated while stirring. In an exemplary embodiment, an electrolyte or an inorganic salt such as NaOH or NaCl may be added thereto in order to adjust an ionic strength of the reaction medium. When the temperature inside the reactor reaches a predetermined level, an initiator, and a water soluble free radical initiator is introduced in order to initiate the reaction. Then, at least one polymerizable monomer and an amphiphilic monomer are added to the reactor using a semi-continuous method. In an exemplary embodiment, a chain transfer agent is also added to the reactor with the at least one polymerizable monomer and the amphiphilic monomer. In the current exemplary embodiment, polymerizable monomers may be slowly provided using a starved feed process in order to adjust a reaction speed and a dispersibility of the solution. In an exemplary embodiment, the polymerization may be performed in the range of about 4 to about 8 hours and the polymerization time may be dependent on the reaction temperature and experimental conditions, and is determined by measuring reaction speed and conversion rate.

Then, the prepared latex particles for a shell layer are coated on the first agglomerated toner in order to obtain toner particles having a desired size and structure, and then the resultant is filtered to separate the toner particles and dried. In an exemplary embodiment, the dried toner particles are subjected to a surface treatment using silica, or the like, and a charge amount is controlled in order to prepare a final dry toner.

Since the amphiphilic monomer used as a comonomer during the polymerization of the latex according to the present general inventive concept maintains stability of the latex in an aqueous solution, a surfactant does not need to be used in the preparation and agglomeration of the polymer latex.

That is, in exemplary embodiments, at least one operation of the preparing the latex particles for a core, the preparing the first agglomerated toner, and the coating the first agglomerated toner with the latex particles for a shell layer may be carried out without a surfactant.

Accordingly, washing processes may be minimized or reduced in the separation and filtration of the prepared toner particles. Manufacturing costs for the toner may therefore be reduced by minimizing the number of washing processes, and the manufacturing process is more environmentally friendly since the amount of wastewater generated is decreased. In addition, problems such as high sensitivity in high humidity, low frictional charge, reduced dielectric property and weak toner flow may be resolved since the surfactant is not used. Also, in exemplary embodiments, a storage stability of the toner may be improved.

In addition, in an exemplary embodiment, when a fine-particle toner is prepared using an amphiphilic monomer instead of a surfactant, the amphiphilic monomer acts as a steric stabilizer, and thus cohesion among the toner particles may be decreased and fluidity of the toner may be improved.

That is, the amphiphilic monomer is on the surface of the latex during polymerization of the latex due to hydrophilicity of the amphiphilic monomer, and the amphiphilic monomer may be formed in a block type by forming an oligomer of the amphiphilic monomer and further adding the hydrophobic polymerizable monomer thereto. The block type amphiphilic monomer formed on the surface of the latex or the oligomer reduces hydrophobicity of the surface of toner, and thereby decreases cohesion among toner particles.

Thus, prepared latex decreases cohesion of toner particles on the surface of a final toner. Thus, it is advantageous that fluidity of the toner can be obtained by using a small amount of an inorganic oxide when a fine-particle toner is prepared.

In order to measure a fluidity of the toner, Carr's cohesion may be used.

In exemplary embodiments, the Carr's cohesion may be about 50 or less when measured by an ASTM D 6393-99.

When the Carr's cohesion is greater than 50, the toner particles may be agglomerated to be course particles in a highly humid environment, and thus a yield of the toner may be decreased.

Meanwhile, the latex particles for a shell layer are coated on the first agglomerated toner, as described above, in order to facilitate a final toner which is to be fixed at a low temperature and also to improve rheological properties of the final toner.

That is, the Theological properties are determined by complex modulus, i.e., storage modulus (G′) and loss modulus (G′) determined by dynamic tests, and controlled by complex viscosity. In addition, relaxation modulus of elasticity and relaxation time can be measured. Such stress-relaxation behavior is affected by molecular weight and structure of a polymer latex in the toner and the amount of wax contained in the toner. When the complex viscosity is relatively low (e.g., 1.0×10² Pas or less), an offset or peeling failure may occur in a fixing device. On the other hand, when the complex viscosity is relatively high (e.g., larger than 1.0×10⁴ Pas), adhesion may not be sufficient when fixed and glossiness may decrease, and thus the toner may not be efficiently applied to a print medium, such as paper.

Meanwhile, when the molecular weight (Mw) of the polymer latex is controlled to be about 30,000 or less, Tg is controlled to be about 50° C., and Theological properties are decreased, the fixing ratio can be increased, but problems such as an offset may occur. Therefore, in order to overcome such problems, a method of cross-linking the latex has been used by controlling the reactivity of the amphiphilic monomer participating in the polymerization. However, problems such as decrease in durability have not been completely overcome.

Accordingly, in the present general inventive concept, the toner is encapsulated by coating the toner with the latex particles for a shell layer in order to improve durability and also to resolve toner storage problems during shipping and handling.

Since the toner is prepared by coating the latex particles for a shell layer on the first agglomerated toner, charge reduction problems caused by a pigment in the first agglomerated toner flowing to the surface of the toner can be resolved.

A volume average diameter of particles of the toner may be in the range of about 5 to about 10 μm.

An alternative exemplary embodiment of the present general inventive concept provides a method of forming images using a toner, the method includes attaching the toner to a surface of a photoreceptor on which an electrostatic latent image is formed to form a visualized image and transferring the visualized image to a transfer medium, wherein the toner has a cohesion level of about 50 or less when measured using an ASTM D 6393-99 and includes a first agglomerated toner including latex particles for a core, a pigment and an inorganic salt, and latex particles for a shell layer coated on the first agglomerated toner, wherein the latex particles for the core and the latex particles for the shell layer are prepared by polymerizing a composition including an amphiphilic monomer having a hydrophilic group, a hydrophobic group and at least one reactive functional group, and a polymerizable monomer.

In an exemplary embodiment, an electrophotographic image forming process includes a series of processes of forming images on a receptor including charging, exposure to light, developing, transferring, fixing, cleaning, and erasing process operations.

In the charging process, a surface of a photoreceptor is charged with negative or positive charges, whichever is desired, by a corona or a charge roller. In the light exposing process, an optical system, conventionally a laser scanner or an array of diodes, selectively discharges the charged surface of the photoreceptor in an imagewise manner which corresponds to a final visual image formed on a final image receptor to form a latent image. Electromagnetic radiation that can be referred to as “light” includes infrared radiation, visible light and ultraviolet radiation.

In the developing process, appropriate polar toner particles generally contact the latent image of the photoreceptor, and conventionally, an electrically-biased developer having an identical potential polarity to the toner polarity is used. The toner particles move to the photoreceptor and are selectively attached to the latent image by electrostatic electricity, and thereby form a toner image on the photoreceptor.

In the transferring process, the toner image is transferred to the final image receptor from the photoreceptor, and sometimes, an intermediate transferring element is used when transferring the toner image from the photoreceptor in order to aid in the transfer of the toner image to the final image receptor.

In the fixing process, the toner image of the final image receptor is heated and the toner particles thereof are softened or melted, thereby fixing the toner image to the final image receptor. In alternative exemplary embodiments, the fixing process fixes the toner image to the final image receptor by using high pressure with or without an application of heat.

In the cleaning process, residual toner remaining on the photoreceptor is removed.

Finally, in the erasing process, charges of the photoreceptor are exposed to light of a predetermined wavelength band and are reduced to be substantially uniform and of a low value, and thus the residue of the organic latent image is removed and the photoreceptor is prepared for a next image forming cycle.

The present general inventive concept also provides an image forming apparatus which includes an organic photoreceptor, an organic photoreceptor charging unit, an image forming unit that forms an electrostatic latent image on a surface of the organic photoreceptor, a unit for receiving a toner, a toner supplying unit that supplies the toner onto the surface of the organic photoreceptor in order to form a toner image by developing the electrostatic latent image, and a toner transferring unit which transfers the toner image to a transfer medium from the surface of the organic photoreceptor, wherein the toner has a cohesion level of about 50 or less when measured using an ASTM D 6393-99 and includes a first agglomerated toner including latex particles for a core, a pigment and an inorganic salt, and latex particles for a shell layer coated on the first agglomerated toner, wherein the latex particles for then core and the latex particles for then shell layer are prepared by polymerizing a composition including an amphiphilic monomer having a hydrophilic group, a hydrophobic group and at least one reactive functional group, and a polymerizable monomer.

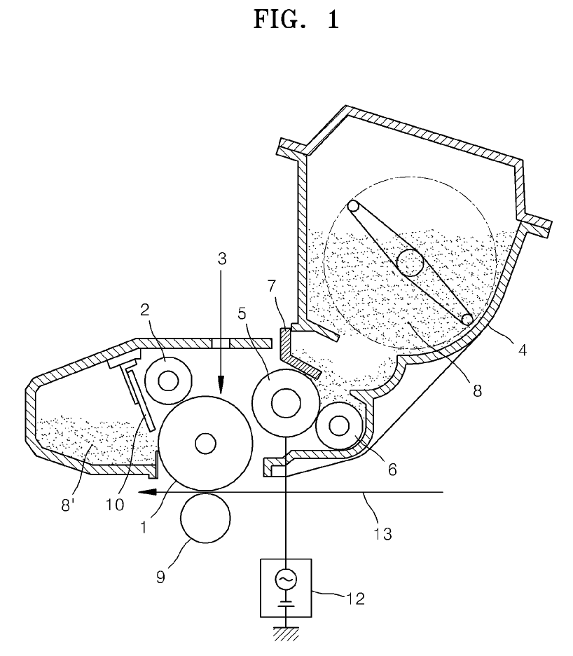

FIG. 1 illustrates a schematic diagram of a non-contact developing type image forming apparatus using toner according to an exemplary embodiment of the present general inventive concept.

A developer 8, which is a nonmagnetic one-component developer, disposed in a developing unit 4 is supplied to a developing roller 5 through a feeding roller 6 which is formed of an elastic material, such as a polyurethane foam or a sponge. The developer 8 which is supplied to the developing roller 5 reaches a contact point between the developing roller 5 and the developer regulation blade 7 while the developing roller 5 rotates. The developer regulation blade 7 is formed of an elastic material such as a metal and a rubber. When the developer 8 passes the contact point between the developing roller 5 and the developer regulation blade 7, the developer 8 is smoothed in order to form a thin layer that is sufficiently charged. The developing roller 5 transfers the thin layer of the developer 8 to a developing domain where the thin layer of the developer 8 is developed on the electrostatic latent image of a photoreceptor 1, which is a latent image carrier. The electrostatic latent image is formed by scanning light 3 onto the photoreceptor 1.

The developing roller 5 and the photoreceptor 1 substantially face each other with a distance disposed therebetween. In exemplary embodiments, the distance between the developing roller 5 and the photoreceptor 1 is constant. The developing roller 5 rotates counterclockwise and the photoreceptor 1 rotates clockwise.

The developer 8 transferred to the developing domain of the photoreceptor 1 forms a toner image by developing an electrostatic latent image on the photoreceptor 1 according to an intensity of an electric charge generated due to a difference between an AC voltage superposed with a DC voltage applied to the developing roller 5 and a latent image potential of the photoreceptor 1 which is charged by a charging unit 2.

The developer 8 developed on the photoreceptor 1 is transferred to a transferring means 9 as the photoreceptor 1 rotates. The developer 8 developed on the photoreceptor 1 is transferred to a sheet of paper 13 by corona discharge or a roller to which a high voltage having an inverse polarity with respect to the developer 8 is applied while the paper 13 passes through the developer 8 developed on the photoreceptor 1, and thus an image is formed.

The image transferred to the printing paper 13 passes through a fixing device (not illustrated) which provides a high temperature and a high pressure, and the image is thereby fused to the printing paper 13 as the developer 8 is fused to the printing paper 13. Meanwhile, the developer 8′ remaining on the developing roller 5 and which is not developed is transferred back to the feeding roller 6 which contacts the developing roller 5. However, remaining or residual developer 8′ that is undeveloped on the photoreceptor 1 is collected by a cleaning blade 10. The above stated processes are repeated for subsequent image forming operations.

The present general inventive concept will be described in more detail with reference to the examples below, however the present general inventive concept is not limited thereto. The following examples are for illustrative purposes only and are not intended to limit the scope of the present general inventive concept.

### EXAMPLE 1

Preparation of Latex Particles for a Core

While an inside of a reactor was purged with nitrogen gas, a mixture solution of 470 g of distilled deionized water and 5 g of poly(ethylene glycol)-ethyl ether methacrylate (PEG-EEM, Aldrich), which was used as an amphiphilic monomer, was added to the reactor and heated while stirring at 250 rpm. When the temperature of the inside of the reactor reached 82° C., 2.0 g of potassium persulfate (KPS) dissolved in 50 g of deionized water when a water soluble free radical initiator was added to the reactor. Then, 100 g of a polymerizable monomer mixture of styrene, n-butyl acrylate and methacrylic acid in a weight ratio of 75:23:2, 3.5 g of 1-dodecanethiol as a chain transfer agent, and 15 g of ester wax were melted at 60° C., and dispersed using ultrasonic waves for 5 minutes, and then added to the reactor maintained at 82° C. for 2 hours. The reaction was performed for 4 to 6 hours, and the resultant was cooled naturally while being stirred. A volume average diameter of the latex particles for a core was 600 nm, and a conversion rate was about 98%.

Preparation of Latex Particles for a Shell Layer

While the inside of a 1 L reactor was purged with nitrogen gas, a mixture solution of 470 g of distilled deionized water and 5 g of poly(ethylene glycol)-ethyl ether methacrylate (PEG-EEM, Aldrich), which was used as an amphiphilic monomer, was added to the reactor and heated while stirring at 300 rpm. When the temperature of the inside of the reactor reached 82° C., 2.0 g of potassium persulfate (KPS) dissolved in 50 g of deionized water when a water soluble free radical initiator was added to the reactor. Then, 100 g of a polymerizable monomer mixture of styrene, n-butyl acrylate and methacrylic acid in a weight ratio of 75:23:2 and 3 g of 1-dodecanethiol as a chain transfer agent were added to the reactor using a starved feed process. The reaction was performed for 4 to 6 hours, and the resultant was cooled naturally while being stirred. A volume average diameter of the latex particles for a core was 350 nm, and a conversion rate was about 98%.

Agglomeration and Preparation of Toner

316 g of deionized water and 307 g of the latex particles for a core prepared according to the process described above were added to a 1 L reactor and stirred at 350 rpm. While stirring, 30 g of a black pigment dispersion (Mogul-L, Cabot K. K.), dispersed by an amphiphilic monomer (HS-10, DiichiKogyo), was added to the reactor. The pH of the mixture was adjusted to 11, 30 g of MgCl₂ was added to the reactor, and the reactor was gradually heated to 95° C. The mixture was reacted at 95° C. for 2 hours, and reacted with NaCl for an additional 2 hours. Then, 100 g of the latex particles for a shell layer was added to the reactor, and the mixture was reacted for 6 hours. Then, the mixture was cooled to a temperature of 25° C. which is below Tg, and filtered in order to separate toner particles and then dried. A volume average diameter of the toner was about 6.5 μm in an intermediate shape between a potato-shape and a spherical shape, and an SEM image thereof is illustrated in FIG. 2.

### EXAMPLE 2

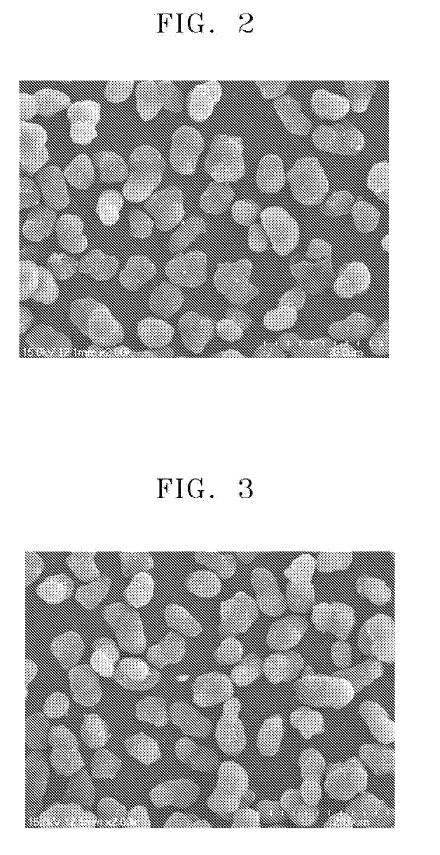

Toner was prepared in the same manner as in Example 1, except that 2.5 g of PEG-EEM, which was used as the amphiphilic monomer, was used in each of the preparations of the latex particles for a core and the latex particles for a shell layer. A volume average diameter of the toner was about 6.2 μm in a potato-shape, and an SEM image thereof is illustrated in FIG. 3.

### EXAMPLE 3

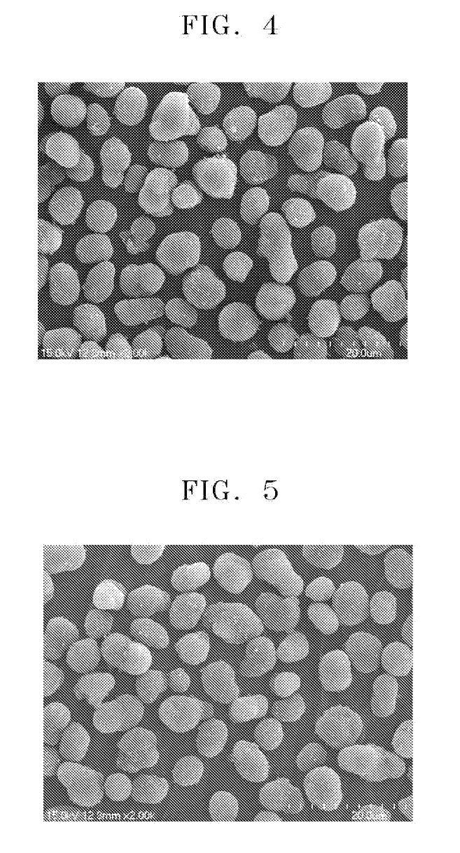

Toner was prepared in the same manner as in Example 1, except that 1.25 g of PEG-EEM, which was used as the amphiphilic monomer, was used in each of the preparations of the latex particles for a core and the latex particles for a shell layer. A volume average diameter of the toner was about 6.4 μm in a potato-shape, and an SEM image thereof is illustrated in FIG. 4.

### EXAMPLE 4

Toner was prepared in the same manner as in Example 1, except that a yellow pigment (PY74, Dinichiseika) was used instead of the black pigment during the agglomeration. A volume average diameter of the toner was about 6.5 μm in a potato-shape, and an SEM image thereof is illustrated in FIG. 5.

### EXAMPLE 5

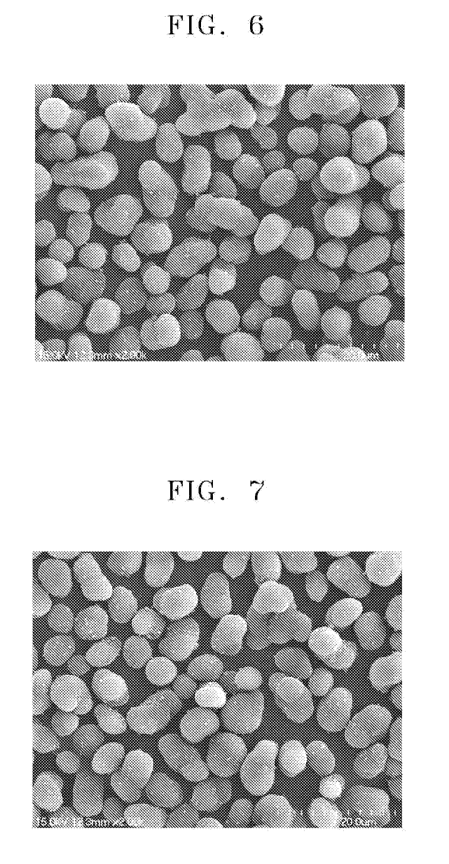

Toner was prepared in the same manner as in Example 1, except that a magenta pigment (PR122, Dinichiseika) was used instead of the black pigment during the agglomeration. A volume average diameter of the toner was about 6.0 μm in a potato-shape, and an SEM image thereof is illustrated in FIG. 6.

### EXAMPLE 6

Toner was prepared in the same manner as in Example 1, except that a cyan pigment (PB15:3, Dinichiseika) was used instead of the black pigment during the agglomeration. A volume average diameter of the toner was about 6.7 μm in a potato-shape, and an SEM image thereof is illustrated in FIG. 7.

### EXAMPLE 7

Toner was prepared in the same manner as in Example 3, except that a yellow pigment (PY74, Dinichiseika) was used instead of the black pigment during the agglomeration. A volume average diameter of the toner was about 6.4 μm in a potato-shape.

### EXAMPLE 8

Toner was prepared in the same manner as in Example 3, except that a magenta pigment (PR122, Dinichiseika) was used instead of the black pigment during the agglomeration. A volume average diameter of the toner was about 6.1 μm in a potato-shape.

### EXAMPLE 9

Toner was prepared in the same manner as in Example 3, except that a cyan pigment (PB15:3, Dinichiseika) was used instead of the black pigment during the agglomeration. A volume average diameter of the toner was about 6.6 μm in a potato-shape.

### COMPARATIVE EXAMPLE 1

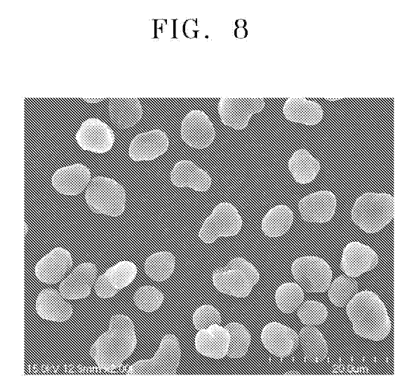

Toner was prepared in the same manner as in Example 1, except that PEG-EEM as an amphiphilic monomer was not used in the preparations of the latex particles for a core and the latex particles for a shell layer. A volume average diameter of the toner was about 6.7 μm in an intermediate shape between potato-shape and spherical shape, and an SEM image thereof is illustrated in FIG. 8.

Evaluation Test

Carr's Cohesion of Toner

Carr's Cohesion of toner prepared according to Examples 1 to 9 and Comparative Example 1 was measure using an ASTM-6393-99. A device for and a method of measuring the Carr's Cohesion of the toner are described in detail.

A powder tester including a digital vibrometer (PT-S, Hosokawa Micron Co.) was used as the device for measuring the Carr's Cohesion of toner.

A 150 μm sieve, a 75 μm sieve and a 45 μm sieve were used in the method. The sieves were stacked in the order of the size, i.e., the 150 μm sieve, the 75 μm sieve and the 45 μm sieve from the top. Then, 4 g of a toner sample was placed on the top sieve (on the 150 μm sieve), and the device was vibrated with the intensity of scale 3 at 1 mm dial of the vibrometer for 10 seconds. As a result, a mass of the residual sample was measured, and Carr's cohesion was calculated using the formulae below.

[(mass of the residual sample on the 150 μm sieve)/4 g]×100 (1)

[(mass of the residual sample of the 75 μm sieve)/4 g]×100×0.6 (2)

[(mass of the residual sample of the 45 μm sieve)/4 g]×100×0.2 (3)

Carr's cohesion=(1)+(2)+(3) (4)

Circularity of Toner

50 SEM images of the toner prepared according to Examples 1 to 6 and Comparative Example 1 were selected, and the circularity of the toner was measured using an Image J software 1.33 u (National Institutes of Health, USA), which analyzes image data using the equation below.

Equation

Circularity=4π^{x}(area/perimeter²)

The circularity can be in the range of 0 to 1, and as the circularity is closer to 1, the toner is most similar to a sphere shape.

Volume Average Diameter of Toner (d50)

A volume average diameter of toner (d50) was measure using a Coulter counter (Multisizer 3, Beckman, USA).

TABLE 1

| | Volume average | | |
|---|---|---|---|
| | diameter | | Carr's Cohesion of |
| Toner | (d50) (μm) | Circularity | toner (%) |
| Example 1 | 6.5 | 0.950 | 40.2 |
| Example 2 | 6.2 | 0.947 | 46.5 |
| Example 3 | 6.4 | 0.943 | 48.5 |
| Example 4 | 6.5 | 0.961 | 45.3 |
| Example 5 | 6.0 | 0.955 | 45.6 |
| Example 6 | 6.7 | 0.960 | 45.5 |
| Example 7 | 6.4 | 0.954 | 48.7 |
| Example 8 | 6.1 | 0.948 | 48.8 |
| Example 9 | 6.6 | 0.953 | 49.1 |
| Comparative | 6.7 | 0.945 | 70.2 |
| Example 1 | | | |

According to Table 1, toner prepared using the amphiphilic monomer according to

Examples 1 to 9 of the present general inventive concept resulted in far less Carr's cohesion than that of the toner prepared without using the amphiphilic monomer according to Comparative Example 1, on similar conditions of volume average diameter and circularity.

As a result, toner of the present general inventive concept can reduce cohesion among toner particles by decreasing hydrophobicity of the surface of toner due to the amphiphilic monomer of the surface of toner. Thus, improvement of fluidity, that is, a low cohesion, of a toner can be achieved.

While a few exemplary embodiments of the present general inventive concept has been particularly shown and described with reference to exemplary embodiments thereof, it will be understood by those of ordinary skill in the art that various changes in form and details may be made therein without departing from the spirit and scope of the present general inventive concept as defined by the following claims.

What is claimed is:

1. A toner having a cohesion level of 50 or less when measured using an ASTM D 6393-99, the toner comprising:
a first agglomerated toner including latex particles for a core, a pigment and an inorganic salt; and
latex particles for a shell layer coated on the first agglomerated toner,
wherein the latex particles for the core and the latex particles for the shell layer are prepared by polymerizing a composition comprising:
an amphiphilic monomer having a hydrophilic group;
a hydrophobic group and at least one reactive functional group; and
a polymerizable monomer.

2. The toner of claim 1, wherein a weight average molecular weight of the amphiphilic monomer is from about 100 to about 100,000.

3. The toner of claim 1, wherein the amphiphilic monomer is selected from the group consisting of polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxy polyester acrylate, fatty acid modified epoxy acrylate, and polyester methacrylate.

4. The toner of claim 1, wherein the composition comprises about 0.5 to about 10 parts by weight of the amphiphilic monomer based on 100 parts by weight of the polymerizable monomer.

5. The toner of claim 1, wherein the polymerizable monomer is at least one monomer selected from the group consisting of styrene-based monomers; acrylic acid, methacrylic acid; derivatives of (metha)acrylates; ethylenically unsaturated monoolefins; halogenized vinyls; vinyl esters; vinyl ethers; vinyl ketones; and nitrogen-containing vinyl compounds.

6. The toner of claim 1, wherein the composition further comprises at least one selected from the group consisting of a wax, an initiator, a chain transfer agent, a charge control agent and a releasing agent.

7. The toner of claim 1, wherein the pigment is selected from the group consisting of yellow, magenta, cyan and black pigments.

8. The toner of claim 1, wherein the inorganic salt is at least one selected from the group consisting of NaCl, MgCl₂.8H₂0, [Al₂(OH)ₙCl₆₋ₙ]ₘ where 1≦n≦5 and 1≦m≦10 and Al₂(SO₄)₃.18H₂O.

9. The toner of claim 1, wherein a volume average diameter of particles of the toner is in the range of about 5 μm to about 10 μm.

10. A method of forming images using a toner, the toner having a cohesion level of 50 or less when measured using an ASTM D 6393-99 includes a first agglomerated toner including latex particles for a core, a pigment and an inorganic salt, and latex particles for a shell layer coated on the first agglomerated toner, wherein the latex particles for the core and the latex particles for the shell layer are prepared by polymerizing a composition comprising an amphiphilic monomer having a hydrophilic group, a hydrophobic group and at least one reactive functional group, and a polymerizable monomer, the method comprising:
attaching the toner to a surface of a photoreceptor on which an electrostatic latent image is formed to form a visualized image; and
transferring the visualized image to a transfer medium.

11. An image forming apparatus comprising:
an organic photoreceptor;
an image forming unit that forms an electrostatic latent image on a surface of the organic photoreceptor;
a unit for receiving a toner, the toner having a cohesion level of 50 or less when measured using an ASTM D 6393-99 includes a first agglomerated toner including latex particles for a core, a pigment and an inorganic salt, and latex particles for a shell layer coated on the first agglomerated toner, wherein the latex particles for the core and the latex particles for the shell layer are prepared by polymerizing a composition comprising an amphiphilic monomer having a hydrophilic group, a hydrophobic group and at least one reactive functional group, and a polymerizable monomer;
a toner supplying unit that supplies the toner onto the surface of the organic photoreceptor in order to form a toner image by developing the electrostatic latent image; and
a toner transferring unit that transfers the toner image to a transfer medium from the surface of the organic photoreceptor.

12. The image forming apparatus of claim 11, wherein the weight average molecular weight of the amphiphilic monomer is from about 100 to about 100,000.

13. The image forming apparatus of claim 11, wherein the amphiphilic monomer is selected from the group consisting of polyethylene glycol (PEG)-methacrylate, polyethylene glycol (PEG)-ethyl ether methacrylate, polyethylene glycol (PEG)-dimethacrylate, polyethylene glycol (PEG)-modified urethane, polyethylene glycol (PEG)-modified polyester, polyacrylamide (PAM), polyethylene glycol (PEG)-hydroxyethyl methacrylate, hexafunctional polyester acrylate, dendritic polyester acrylate, carboxy polyester acrylate, fatty acid modified epoxy acrylate, and polyester methacrylate.

14. The image forming apparatus of claim 11, wherein the composition comprises about 0.5 to about 10 parts by weight of the amphiphilic monomer based on 100 parts by weight of the polymerizable monomer.

15. The image forming apparatus of claim 11, wherein the polymerizable monomer is at least one monomer selected from the group consisting of styrene-based monomers; acrylic acid, methacrylic acid; derivatives of (metha)acrylates; ethylenically unsaturated monoolefins; halogenized vinyls; vinyl esters; vinyl ethers; vinyl ketones; and nitrogen-containing vinyl compounds.

16. The image forming apparatus of claim 11, wherein the composition further comprises at least one selected from the group consisting of a wax, an initiator, a chain transfer agent, a charge control agent and a releasing agent.
